(19) United States
(12) Patent Application Publication
(10) Pub. No.: US 2026/0244354 A1
(43) Pub. Date: Aug. 20, 2026

(54) SYSTEM BOOT RESILIENCY WITH A DISCHARGED COMPLEMENTARY METAL-OXIDE SEMICONDUCTOR BATTERY

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Amit K. Tiwari, Austin, TX (US); Marcin Nowak, Prosper, TX (US)

(21) Appl. No.: 19/056,345

(22) Filed: Feb. 18, 2025

(51) Int. Cl. G06F 3/06

(52) U.S. Cl. CPC G06F 3/0629; G06F 3/0619; G06F 3/0679

(57) ABSTRACT

An information handling system monitors a battery charge level of a complementary metal-oxide semiconductor (CMOS) battery. in response to detecting that the battery charge level reaches a threshold level, the system back ups configuration data stored in a CMOS memory associated with the CMOS battery. In response to detect that the CMOS battery has been replaced, the system restores the configuration data to the CMOS memory.

### FIELD OF THE DISCLOSURE

The present disclosure generally relates to information handling systems, and more particularly relates to system boot resiliency with a discharged complementary metal-oxide semiconductor battery.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may monitor a battery charge level of a complementary metal-oxide semiconductor (CMOS) battery. In response to detecting that the battery charge level reaches a threshold level, the system may back up configuration data stored in a CMOS memory associated with the CMOS battery. In response to detecting that the CMOS battery has been replaced, the system may restore the configuration data to the CMOS memory.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system configured for system boot resiliency with a discharged complementary metal-oxide semiconductor (CMOS) battery, according to an embodiment of the present disclosure;

FIGS. 2 – 4 are flowcharts of methods for system boot resiliency with a discharged CMOS battery, according to an embodiment of the present disclosure; and

FIG. 5 is a block diagram of an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

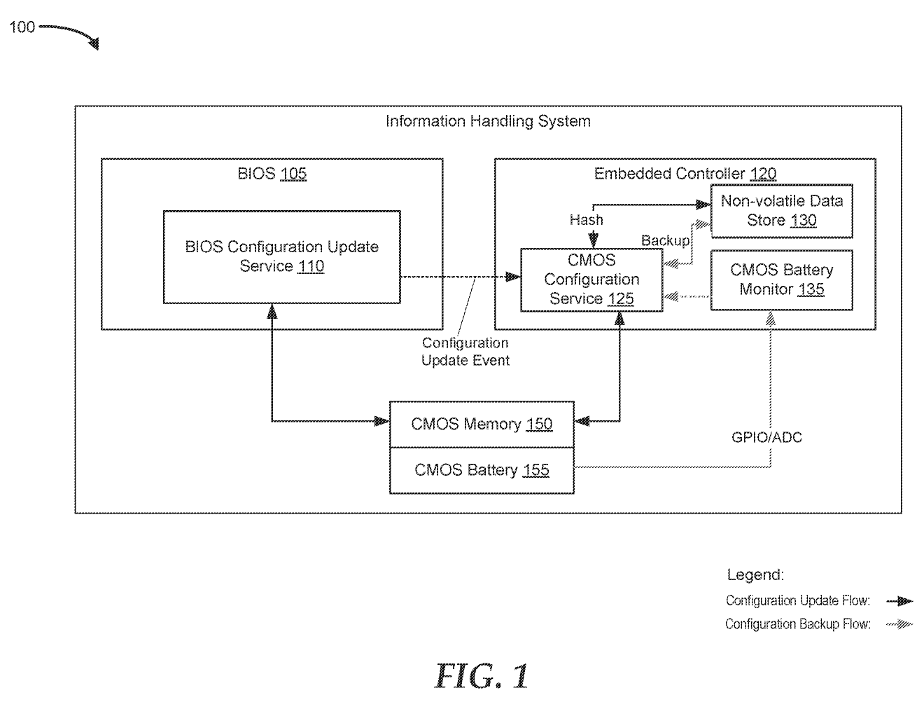

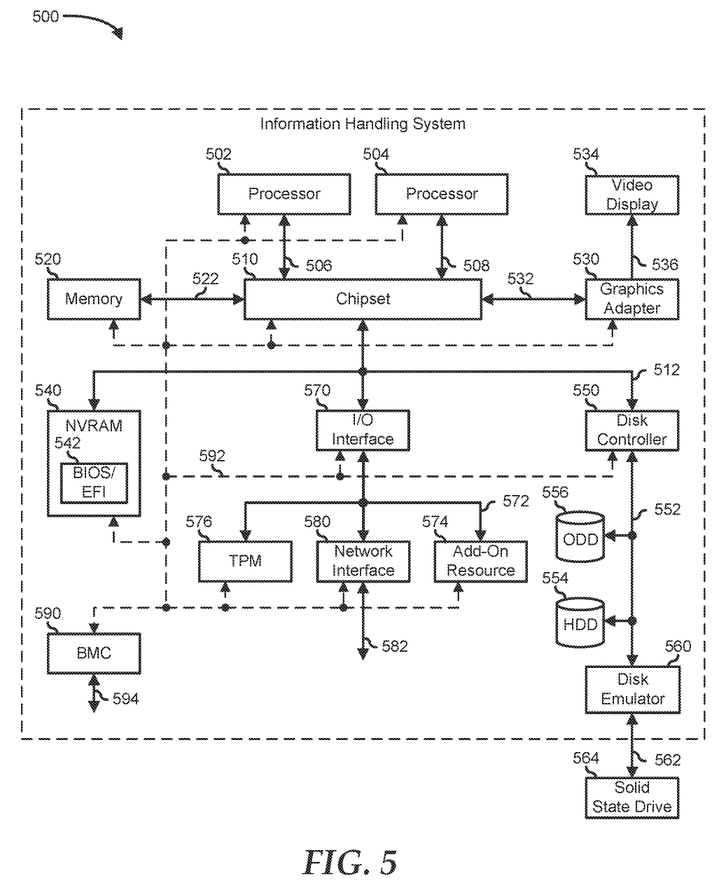

FIG. 1 illustrates a portion of an information handling system 100 configured for system boot resiliency with a discharged complementary metal-oxide semiconductor (CMOS) battery, according to an embodiment of the present disclosure. Information handling system 100, which is similar to information handling system 500 of FIG. 5, includes a basic input/output system (BIOS) 105, an embedded controller 120, a CMOS memory 150, and a CMOS battery 155. BIOS 105 includes a BIOS configuration update service 110. Embedded controller 120 includes a CMOS configuration service 125, a non-volatile data store 130, and a CMOS battery monitor 135. BIOS 105 may be connected to embedded controller 120 along with CMOS memory 150 and CMOS battery 155. However, any variety of connections between BIOS 105 and embedded controller 120 are envisioned as falling within the scope of the present disclosure. In addition, connections between components may be omitted for descriptive clarity. The operations described herein as being performed by BIOS 105 and embedded controller 120 may be performed or executed by a processor.

Generally, information handling systems are designed with battery-backed CMOS memory to store the boot critical configuration data and/or information that is persistent across the boot cycles. As such, the data integrity of the configuration data and/or information saved in battery-backed CMOS memory is critical for the system to boot normally. CMOS batteries, which are typically coin cell batteries, are designed for robust usage with a long life. However, there are still chances where the battery may fail. When the battery fails, the configuration data and/or information stored in the CMOS memory may be lost or corrupted. This may lead to a boot issue, such as no post and/or no video error without exhibiting an error code for the user. For example, a user may power up his notebook after an extended period of time using an AC power adapter as the charge notebook’s battery is fully drained. The notebook encountered no post error during the boot process as the charge of the coin cell battery was also fully drained. As such the user may have to call or take his notebook to a service center to repair the boot issue. To address this and other concerns, the present disclosure provides a system and method that can ensure the data integrity of CMOS memory and identify the failure cases in advance so that configuration data and/or information in the CMOS memory can be backed up and avoid associated boot issues.

BIOS 105, which is similar to BIOS/extensible firmware interface (BIOS/EFI) module 542 of FIG. 5, may include any system, device, or apparatus configured to identify, test, and/or initialize information handling resources of information handling system 100 and/or initialize interoperation of information handling system 100 with other information handling systems. “BIOS” may broadly refer to any system, device, or apparatus configured to perform such functionality, including without limitation a Unified Extensible Firmware Interface (UEFI). In some embodiments, BIOS 105 may be implemented as a program of instructions that may be read by and executed on a processor to carry out the functionality of BIOS 105.

BIOS configuration update service 110 may include any system, device, or apparatus configured to update configuration data and/or information stored in CMOS memory 150. For example, CMOS memory 150 may be configured to store configuration data and/or information such as date, time, and BIOS and/or hardware settings. After the update, BIOS configuration update service 110 may send a notification to CMOS configuration service 125 to recalculate a hash of the configuration data and/or information stored in CMOS memory 150. The hash may be calculated using a hashing algorithm, such as a secure hashing algorithm (SHA) like SHA256 or SHA512. Such hash functions may be configured to generate a fixed-length value utilizing at least the configuration data and/or information, with the fixed-length value having substantially less than a length of the data item itself. CMOS battery 155 is typically a coin cell battery on a motherboard of information handling system 100. CMOS battery 155 may be configured to provide power to a CMOS chip that includes CMOS memory 150.

Embedded controller 120, which is similar to BMC 590 of FIG. 5, may include any system, device, or apparatus, such as a microcontroller on a motherboard of information handling system 100. Embedded controller 120 includes CMOS configuration service 125 which may be configured to receive a configuration update event from BIOS configuration update service 110 or embedded controller 120. The configuration update event may indicate to BIOS configuration update service 110 or embedded controller 120 to update the configuration data and/or information in CMOS memory 150. The configuration update event may also be indicative to back up the configuration data and/or information in CMOS memory 150. For example, a configuration update event may be transmitted by BIOS configuration update service 110 when information handling system 100 is changing its sleep state and a backup flag is set to true.

Upon receipt of the configuration update event, CMOS configuration service 125 may update the configuration data and/or information stored in CMOS memory 150. After the update, CMOS configuration service 125 may calculate a hash of the updated configuration data and/or information and store the hash in non-volatile data store 130. In addition, CMOS configuration service 125 may back up the updated configuration data and/or information stored in CMOS memory 150 to non-volatile data store 130. In another embodiment, CMOS configuration service 125 may take a snapshot of the configuration data and/or information in CMOS memory 150 and store the snapshot in non-volatile data store 130 along with a hash of the snapshot. CMOS configuration service 125 may also be configured to restore the backup to CMOS memory 150 based on a notification event from BIOS configuration update service 110, CMOS battery monitor 135, and/or embedded controller 120.

Embedded controller 120 also includes CMOS battery monitor 135 configured to monitor the status of CMOS battery 155 continuously or periodically. CMOS battery monitor 135 may monitor various battery status metrics, such as temperature, battery charge level, and overall health through a general-purpose input/output (GPIO) pin or an analog-to-digital converter (ADC). When CMOS battery monitor 135 and/or embedded controller 120 detects that the charge level of CMOS battery 155 is reaching a threshold level, embedded controller 120 may notify CMOS configuration service 125 and/or BIOS 105. For example, embedded controller 120 may notify CMOS configuration service 125 and/or BIOS 105 that the charge level of CMOS battery 155 is within a certain percentage of reaching the threshold level. BIOS 105 may then notify a user, such as via a warning message that CMOS battery 155 may need to be replaced. BIOS 105 may also log the warning message.

Upon reaching the threshold level, CMOS battery monitor 135 may notify CMOS configuration service 125 to initiate a backup of the configuration data and/or information stored in CMOS memory 150 to non-volatile data store 130, such as when the system sleep state of information handling system 100 is changing from one sleep state to another sleep state. Typically, an information handling system supports multiple power states that correspond to the sleep states defined in the Advanced Configuration and Power Interface (ACPI) specification. For example, the information handling system may support S1, S2, S3, and S4 states. CMOS configuration service 125 may restore the configuration data stored in non-volatile data store 130 to CMOS memory 150 in response to a notification from CMOS battery monitor 135 when it detects that CMOS battery 155 is replaced and the battery charge level is at a normal level.

While information handling system 100 is in one of the system sleeping states or a storage mode, such as when information handling system 100 has not been powered on for at least a week, embedded controller 120 may be configured to receive a wakeup event from CMOS battery 155 whenever the battery charge level of CMOS battery 155 drops to the threshold level. Upon receipt of the wakeup event, embedded controller 120 may wake up and take a backup of the configuration data and/or information stored in CMOS memory 150 and store the configuration data and/or information in non-volatile data store 130. In case a main battery of information handling system 100 is drained, embedded controller 120 may copy a latest available backup of the configuration data and/or information stored in non-volatile data store 130 to populate CMOS memory 150 when CMOS battery 155 is replaced. If there is no available backup of the configuration data and/or information, then embedded controller 120 may populate CMOS memory 150 with default configuration data and/or information.

To ensure data integrity of the configuration data and/or information stored in CMOS memory 150, embedded controller 120 may be configured to keep track of updates to the configuration data and/or information in CMOS memory 150 and perform data integrity checks. For example, CMOS configuration service 125 of embedded controller 120 may take a snapshot of the configuration data and/or information after each update and calculate a hash of the snapshot. The hash and/or the snapshot may be backed up or stored in non-volatile data store 130. Upon each boot of information handling system 100, embedded controller 120 may ensure the data integrity of the configuration data stored in CMOS memory 150 before using it. For example, CMOS configuration service 125 may take a snapshot of the current configuration data in CMOS memory 150, calculate a hash of the snapshot, and compare the calculated hash with the hash in non-volatile data store 130, such as the latest hash. If the hashes match, then the boot process may proceed. Otherwise, embedded controller 120 may direct BIOS 105 to boot with a default configuration data, to avoid a boot issue, such as a no-post scenario.

Those of ordinary skill in the art will appreciate that the configuration, hardware, and/or software components of information handling system 100 depicted in FIG. 1 may vary. For example, the illustrative components within information handling system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

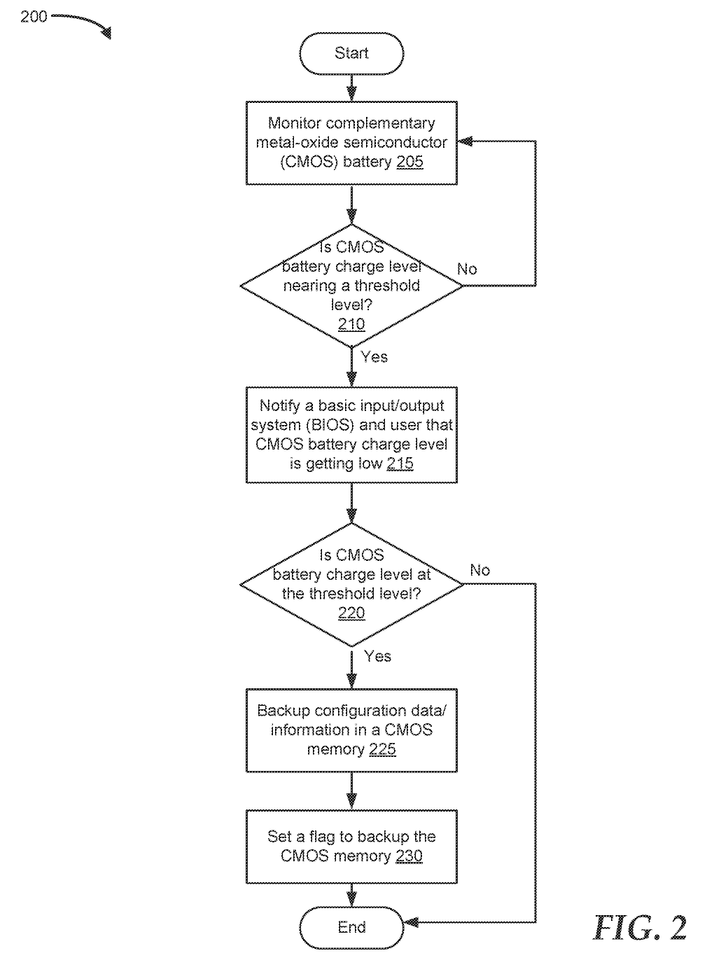

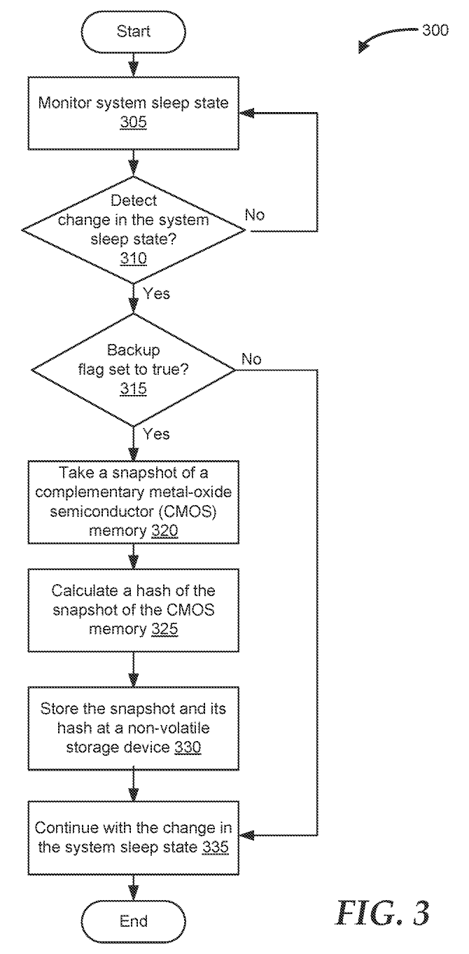

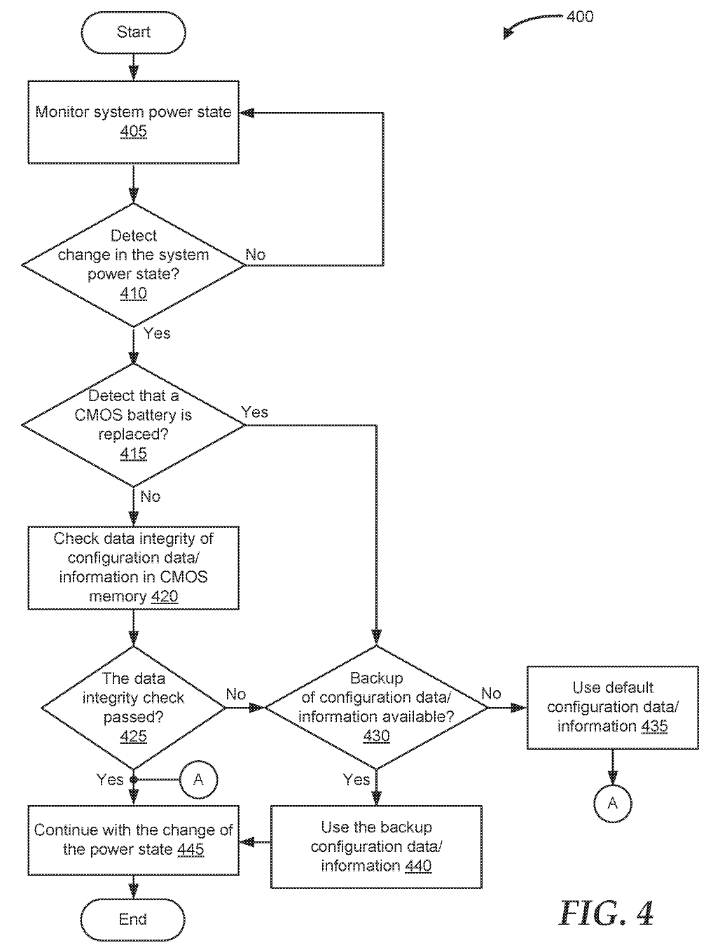

FIG. 2 illustrates a portion of a flowchart of a method 200 to backup CMOS memory for system boot resiliency with a discharged CMOS battery, according to an embodiment of the present disclosure. Method 200 may be performed by any suitable component of information handling system 100 including, but not limited to, BIOS 105 and embedded controller 120 of FIG. 1. While embodiments of the present disclosure are described in terms of the components of information handling system 100 of FIG. 1, it should be recognized that other components may be utilized to perform the described method. It will be readily appreciated that not every method step set forth in this flow chart is always necessary and that certain steps of the methods may be combined, performed simultaneously, in a different order, or perhaps omitted, without varying from the scope of the disclosure. In addition, one of skill in the art will appreciate that this flow chart explains a typical example, which can be extended to applications or services in practice.

Method 200 typically starts at a block 205 where an embedded controller may monitor the battery charge level of a CMOS battery of an information handling system. The method may proceed to a decision block 210 where the embedded controller may determine if the battery charge level of the CMOS battery is nearing a threshold battery charge level. For example, the embedded controller may determine whether the battery charge level of the CMOS battery is within a pre-determined percentage level. In one example, the pre-determined percentage level may be set to five percent while the threshold battery charge level may be set to ten percent. Accordingly, in this particular example, if the battery charge level of the CMOS battery is at least 15% or lower, then the battery charge level of the CMOS battery may be deemed as nearing the threshold battery charge level. If the battery charge level of the CMOS battery is nearing a threshold battery charge level, then the “YES” branch is taken, and the method may proceed to block 215. If the battery charge level of the CMOS battery is not nearing a threshold battery charge level, then the “NO” branch is taken, and the method may proceed to block 205 and continue with the monitoring.

At block 215, the embedded controller may notify a BIOS and a user that the battery charge level of the CMOS battery is nearing the threshold battery charge level or getting low. For example, the embedded controller may send a warning message to replace the CMOS battery. The method may proceed to a decision block 220 where the embedded controller may determine whether the battery charge level of the CMOS battery is at the threshold level. In this example, the embedded controller may determine whether the battery charge level of the CMOS battery is at least ten percent or lower. If the battery charge level of the CMOS battery is at the threshold level or lower, then the “YES” branch is taken, and the method may proceed to a block 225. If the battery charge level of the CMOS battery is higher than the threshold level, then the “NO” branch is taken, and the method ends.

At block 225, the embedded controller may perform a backup of the configuration data and/or other information in a CMOS memory associated with the CMOS battery. As part of the backup process, the embedded controller may take a snapshot of the configuration data and/or information stored in the CMOS memory. After taking a snapshot, the embedded controller may calculate a hash of the snapshot. The snapshot and the hash may be stored in a non-volatile storage device associated with the embedded controller. The method may proceed to a block 230, where the embedded controller may set a flag to back up the CMOS memory. Afterward, the method ends.

FIG. 3 illustrates a portion of a flowchart of a method 300 for system boot resiliency with a discharged CMOS battery, according to an embodiment of the present disclosure. Method 300 may be performed by any suitable component of information handling system 100 including, but not limited to, BIOS 105 and embedded controller 120 of FIG. 1. While embodiments of the present disclosure are described in terms of the components of information handling system 100 of FIG. 1, it should be recognized that other components may be utilized to perform the described method. It will be readily appreciated that not every method step set forth in this flow chart is always necessary and that certain steps of the methods may be combined, performed simultaneously, in a different order, or perhaps omitted, without varying from the scope of the disclosure. In addition, one of the skills in the art will appreciate that this flow chart explains a typical example, which can be extended to applications or services in practice.

Method 300 typically starts at a block 305 where an embedded controller may monitor system sleep state of the information handling system. The method may proceed to a decision block 310 where the embedded controller may determine whether it detects a change in the system sleep state of the information handling system, such as a transition from one system sleep state to another sleep state or a transition from a system sleep state to a working state. For example, the information handling system wakes up from a sleeping or a hibernating state. One of skill in the art will appreciate that there are other system sleeping states than those shown in the example. If the embedded controller detects a change in the system sleep state, then the “YES” branch is taken, and the method may proceed to a decision block 315. If the embedded controller does not detect a change in the system sleep state, then the “NO” branch is taken, and the method may proceed to block 315 where it continues monitoring the system sleep state.

At decision block 315, the embedded controller may determine whether a backup flag is set to true. The backup flag may indicate whether to perform a backup of the CMOS memory. In this example, the backup flag may be set to true to indicate that the backup may be performed. Accordingly, the backup flag may be set to false to indicate that the backup may not be performed. However, one of skill in the art will appreciate that other means to determine whether to backup the CMOS memory may be used, such as a backup variable or a registry setting. If the backup flag is set to true, then the “YES” branch is taken, and the method may proceed to a block 320. If the backup flag is not set to true, then the “NO” branch is taken, and the method may proceed to a block 335.

At block 320, the method may take a snapshot of the configuration data and/or information stored in the CMOS memory. After taking a snapshot, the embedded controller may proceed to a block 325 where the embedded controller may calculate a hash of the snapshot. The method may then proceed to a block 330, where the embedded controller may store the snapshot and the hash in a non-volatile storage device associated with the embedded controller. The method may proceed to block 335, where the information handling system may continue with the change or transition of the information handling system from the system sleep state to another system state or a working state.

FIG. 4 illustrates a portion of a flowchart of a method 400 for system boot resiliency with a discharged CMOS battery, according to an embodiment of the present disclosure. Method 400 may be performed by any suitable component of information handling system 100 including, but not limited to, BIOS 105 and embedded controller 120 of FIG. 1. While embodiments of the present disclosure are described in terms of the components of information handling system 100 of FIG. 1, it should be recognized that other components may be utilized to perform the described method. It will be readily appreciated that not every method step set forth in this flow chart is always necessary and that certain steps of the methods may be combined, performed simultaneously, in a different order, or perhaps omitted, without varying from the scope of the disclosure. In addition, one of skill in the art will appreciate that this flow chart explains a typical example, which can be extended to applications or services in practice.

Method 400 typically starts at a block 405 where an embedded controller may monitor system power states of the information handling system. The method may proceed to a decision block 410 where the embedded controller may determine whether it detects a change in the system power state. Typically, an information handling system supports multiple power states that correspond to the power states defined in the ACPI specification. For example, the information handling system may support a working state, sleep state, hibernate state, and off state. If the embedded controller detects a transition from one system power state to another system power state, then the “YES” branch is taken, and the method may proceed to a decision block 415. If the embedded controller does not detect a transition from one system power state to another system power state, then the “NO” branch is taken, and the method may proceed to block 405.

At decision block 415, the embedded controller may determine whether the CMOS battery has been replaced, such as after the CMOS battery has been drained. The CMOS battery may be drained when it is completely discharged so it cannot provide the required power. At some point, the embedded controller may also have detected that the CMOS battery has been drained. If the embedded controller detects that the CMOS battery is not replaced, then the “NO” branch is taken, and the method may proceed to block 420. If the CMOS battery is drained, then the “YES” branch is taken, and the method may proceed to block 430.

At block 420, the embedded controller may check the data integrity of configuration data and/or information stored in CMOS memory. The data integrity check may be performed by comparing and verifying that the hash of the configuration data and/or information stored in the non-volatile data store matches the hash of the configuration data and/or information stored in the CMOS memory. The method may proceed to decision block 425, wherein the embedded controller may determine whether the data integrity check passed. The data integrity check passes if both hashes are equal. If the data integrity check did not pass, then the “NO” branch is taken, and the method may proceed to a decision block 430. If the data integrity check passes, then the “YES” branch is taken, and the method may proceed to block 445.

At decision block 430, the embedded controller may determine whether the backup of the configuration data and/or information stored in the non-volatile data store is available. If the backup is not available, then the “NO” branch is taken, and the method may proceed to a block 435. If the backup is available, then the “YES” branch is taken, and the method may proceed to a block 440.

At block 435, the embedded controller may use a default configuration data and/or information and copy the default configuration data and/or information to the CMOS memory. At block 440, the embedded controller may use a latest backup of the configuration data and/or information and copy the latest backup of the configuration data and/or information to the CMOS memory. At block 445, the information handling system may continue with the change of power state. Afterward, the method ends.

FIG. 5 illustrates an embodiment of an information handling system 500 including processors 502 and 504, a chipset 510, a memory 520, a graphics adapter 530 connected to a video display 534, a non-volatile RAM (NVRAM) 540 that includes a basic input and output system/extensible firmware interface (BIOS/EFI) module 542, a disk controller 550, a hard disk drive (HDD) 554, an optical disk drive 556, a disk emulator 560 connected to an SSD 564, an I/O interface 570 connected to an add-on resource 574 and a trusted platform module (TPM) 576, a network interface 580, and a baseboard management controller (BMC) 590. Processor 502 is connected to chipset 510 via processor interface 506, and processor 504 is connected to the chipset via processor interface 508. In a particular embodiment, processors 502 and 504 are connected together via a high-capacity coherent fabric, such as a HyperTransport link, a QuickPath Interconnect, or the like. Chipset 510 represents an integrated circuit or group of integrated circuits that manage the data flow between processors 502 and 504 and the other elements of information handling system 500. In a particular embodiment, chipset 510 represents a pair of integrated circuits, such as a northbridge component and a southbridge component. In another embodiment, some or all of the functions and features of chipset 510 are integrated with one or more of processors 502 and 504.

Memory 520 is connected to chipset 510 via a memory interface 522. An example of memory interface 522 includes a Double Data Rate (DDR) memory channel and memory 520 represents one or more DDR Dual In-Line Memory Modules (DIMMs). In a particular embodiment, memory interface 522 represents two or more DDR channels. In another embodiment, one or more of processors 502 and 504 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 520 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, and the like. Graphics adapter 530 is connected to chipset 510 via a graphics interface 532 and provides a video display output 536 to a video display 534. An example of a graphics interface 532 includes a Peripheral Component Interconnect-Express (PCIe) interface and graphics adapter 530 can include a four-lane (x4) PCIe adapter, an eight-lane (x8) PCIe adapter, a 16-lane (x16) PCIe adapter, or another configuration, as needed or desired. In a particular embodiment, graphics adapter 530 is provided down on a system printed circuit board (PCB). Video display output 536 can include a Digital Video Interface (DVI), a High-Definition Multimedia Interface (HDMI), a DisplayPort interface, or the like, and video display 534 can include a monitor, a smart television, an embedded display such as a laptop computer display, or the like.

NVRAM 540, disk controller 550, and I/O interface 570 are connected to chipset 510 via an I/O channel 512. An example of I/O channel 512 includes one or more point-to-point PCIe links between chipset 510 and each of NVRAM 540, disk controller 550, and I/O interface 570. Chipset 510 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 540 includes BIOS/EFI module 542 that stores machine-executable code (BIOS/EFI code) that operates to detect the resources of information handling system 500, to provide drivers for the resources, to initialize the resources, and to provide common access mechanisms for the resources. The functions and features of BIOS/EFI module 542 will be further described below.

Disk controller 550 includes a disk interface 552 that connects the disc controller to an HDD 554, to an optical disk drive (ODD) 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an institute of electrical and electronics engineers (IEEE) 1394 (Firewire) interface, a proprietary interface, or a combination thereof. Alternatively, SSD 564 can be disposed within information handling system 500.

I/O interface 570 includes a peripheral interface 572 that connects the I/O interface to add-on resource 574, to TPM 576, and to network interface 580. Peripheral interface 572 can be the same type of interface as I/O channel 512 or can be a different type of interface. As such, I/O interface 570 extends the capacity of I/O channel 512 when peripheral interface 572 and the I/O channel are of the same type, and the I/O interface translates information from a format suitable to the I/O channel to a format suitable to the peripheral interface 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board, or add-in card disposed within information handling system 500, a device that is external to the information handling system, or a combination thereof.

Network interface 580 represents a network communication device disposed within information handling system 500, on a main circuit board of the information handling system, integrated onto another component such as chipset 510, in another suitable location, or a combination thereof. Network interface 580 includes a network channel 582 that provides an interface to devices that are external to information handling system 500. In a particular embodiment, network channel 582 is of a different type than peripheral interface 572 and network interface 580 translates information from a format suitable to the peripheral channel to a format suitable to external devices.

In a particular embodiment, network interface 580 includes a NIC or host bus adapter (HBA), and an example of network channel 582 includes an InfiniBand channel, a Fibre Channel, a Gigabit Ethernet channel, a proprietary channel architecture, or a combination thereof. In another embodiment, network interface 580 includes a wireless communication interface, and network channel 582 includes a Wi-Fi channel, a near-field communication (NFC) channel, a Bluetooth^{®} or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 582 can be connected to an external network resource (not illustrated). The network resource can include another information handling system, a data storage system, another network, a grid management system, another suitable resource, or a combination thereof.

BMC 590 is connected to multiple elements of information handling system 500 via one or more management interface 592 to provide out-of-band monitoring, maintenance, and control of the elements of the information handling system. As such, BMC 590 represents a processing device different from processor 502 and processor 504, which provides various management functions for information handling system 500. For example, BMC 590 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 590 can vary considerably based on the type of information handling system. BMC 590 can operate in accordance with an Intelligent Platform Management Interface (IPMI). Examples of BMC 590 include an Integrated Dell^{®} Remote Access Controller (iDRAC).

Management interface 592 represents one or more out-of-band communication interfaces between BMC 590 and the elements of information handling system 500 and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 502 and 504 and procedures that are implemented on the information handling system in response to the executed code.

BMC 590 operates to monitor and maintain system firmware, such as code stored in BIOS/EFI module 542, option ROMs for graphics adapter 530, disk controller 550, add-on resource 574, network interface 580, or other elements of information handling system 500, as needed or desired. In particular, BMC 590 includes a network interface 594 that can be connected to a remote management system to receive firmware updates, as needed or desired. Here, BMC 590 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 590 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 590, an interface defined by the Distributed Management Taskforce (DMTF) (such as a Web Services Management (WSMan) interface, a Management Component Transport Protocol (MCTP) or, a Redfish^{®} interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 590 is included on a main circuit board (such as a baseboard, a motherboard, or any combination thereof) of information handling system 500 or is integrated into another element of the information handling system such as chipset 510, or another suitable element, as needed or desired. As such, BMC 590 can be part of an integrated circuit or a chipset within information handling system 500. An example of BMC 590 includes an iDRAC, or the like. BMC 590 may operate on a separate power plane from other resources in information handling system 500. Thus BMC 590 can communicate with the management system via network interface 594 while the resources of information handling system 500 are powered off. Here, information can be sent from the management system to BMC 590 and the information can be stored in a RAM or NVRAM associated with the BMC. Information stored in the RAM may be lost after power-down of the power plane for BMC 590, while information stored in the NVRAM may be saved through a power-down/power-up cycle of the power plane for the BMC.

Information handling system 500 can include additional components and additional busses, not shown for clarity. For example, information handling system 500 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 500 can include multiple central processing units (CPUs) and redundant bus controllers. One or more components can be integrated together. Information handling system 500 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure, information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 500 can include processing resources for executing machine-executable code, such as processor 502, a programmable logic array (PLA), an embedded device such as a System-on-a-Chip (SoC), or other control logic hardware. Information handling system 500 can also include one or more computer-readable media for storing machine-executable code, such as software or data.

Although FIG. 2, FIG. 3, and FIG. 4 show example blocks of method 200, method 300, and method 400 in some implementations, method 200, method 300, and method 400 may include additional blocks, fewer blocks, different blocks, or differently arranged blocks than those depicted in FIG. 2, FIG. 3, and FIG. 4. Those skilled in the art will understand that the principles presented herein may be implemented in any suitably arranged processing system. Additionally, or alternatively, two or more of the blocks of method 200, method 300, and method 400 may be performed in parallel. For example, blocks 225 and 230 of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
monitoring, by a processor of an information handling system, a battery charge level of a complementary metal-oxide semiconductor (CMOS) battery of the information handling system;
in response to detecting that the battery charge level reaches a threshold level, backing up configuration data stored in a CMOS memory associated with the CMOS battery of the information handling system when the information handling system transitions from a power state to another power state; and
in response to detecting that the CMOS battery has been replaced and the battery charge level is at a normal level, restoring the configuration data to the CMOS memory.

2. The method of claim 1, wherein the backing up of the configuration data is performed when a change in a system sleep state of the information handling system is detected.

3. The method of claim 2, wherein the backing up of the configuration data includes taking a snapshot of the configuration data and storing the snapshot in a non-volatile memory associated with an embedded controller.

4. The method of claim 3, wherein the backing up of the configuration data includes calculating a hash of the snapshot of the configuration data and storing the hash in the non- volatile memory associated with the embedded controller.

5. The method of claim 1, further comprising performing a data integrity check of the configuration data stored in the CMOS memory.

6. The method of claim 5, wherein the restoring of the configuration data to the CMOS memory is further performed subsequent to a failure of the data integrity check.

7. The method of claim 1, further comprising determining whether the CMOS battery has been replaced in response to detecting a change in a system power state.

8. The method of claim 1, further comprising storing a default configuration data in the CMOS memory in response to determining that the configuration data stored in the CMOS memory is not backed up when the CMOS battery is replaced.

9. The method of claim 1, wherein the backing up of the configuration data stored in the CMOS memory is further performed in response to detecting a change in a system sleep state.

10. An information handling system, comprising:
a processor; and
a memory coupled to the processor, the memory having program instructions stored thereon that upon execution cause the processor to:
monitor a battery charge level of a complementary metal-oxide semiconductor (CMOS) battery;
in response to detecting that the battery charge level reaches a threshold level, back up configuration data stored in a CMOS memory associated with the CMOS battery when the information handling system transitions from a power state to another power state; and
in response to detecting that the CMOS battery has been replaced and the battery charge level is at a normal level, restore the configuration data to the CMOS memory.

11. The information handling system of claim 10, wherein the back up of the configuration data is performed when a change in a system sleep state is detected.

12. The information handling system of claim 10, wherein the back up of the configuration data further includes the processor to take a snapshot of the configuration data and store the snapshot in a non-volatile memory associated with an embedded controller.

13. The information handling system of claim 12, wherein the back up of the configuration data further includes the processor to calculate a hash the snapshot of the configuration data and store the hash in the non-volatile memory associated with the embedded controller.

14. The information handling system of claim 10, wherein the program instructions further comprise the processor to perform a data integrity check of the configuration data stored in the CMOS memory.

15. A non-transitory computer-readable medium to store instructions that are executable to perform operations comprising:
monitoring a battery charge level of a complementary metal-oxide semiconductor (CMOS) battery;
in response to detecting that the battery charge level reaches a threshold level, backing up configuration data stored in a CMOS memory associated with the CMOS battery when the information handling system transitions from a power state to another power state; and
in response to detecting that the CMOS battery has been replaced, restoring the configuration data to the CMOS memory.

16. The non-transitory computer-readable medium of claim 15, wherein the backing up of the configuration data is performed when a change in a system sleep state is detected.

17. The non-transitory computer-readable medium of claim 15, wherein the backing up of the configuration data includes taking a snapshot of the configuration data and storing the snapshot in a non-volatile memory associated with an embedded controller.

18. The non-transitory computer-readable medium of claim 15, wherein the operations further comprise performing a data integrity check of the configuration data stored in the CMOS memory.

19. The non-transitory computer-readable medium of claim 18, wherein the restoring of the configuration data to the CMOS memory is further performed subsequent to a failure of the data integrity check.

20. The non-transitory computer-readable medium of claim 15, wherein the operations further comprise determining whether the CMOS battery has been replaced in response to detecting a change in a system power state.
